(19) United States
(12) Patent Application Publication
(10) Pub. No.: US 2026/0358734 A1
(43) Pub. Date: Nov. 12, 2026

(54) DEVELOPING DEVICE AND IMAGE FORMING APPARATUS INCLUDING SAME

(71) Applicants: Hiroki Miyata, Kanagawa (JP); Yuuki Tsuchiya, Kanagawa (JP)

(72) Inventors: Hiroki Miyata, Kanagawa (JP); Yuuki Tsuchiya, Kanagawa (JP)

(73) Assignee: ETRIA Co., Ltd., Kanagawa (JP)

(21) Appl. No.: 19/652,022

(22) Filed: Apr. 20, 2026

(30) Foreign Application Priority Data
May 9, 2025 (JP) 2025-078889

(51) Int. Cl. G03G 15/08

(52) U.S. Cl. CPC G03G 15/0812; G03G 15/0808; G03G 15/0891

(57) ABSTRACT

A developing device includes: a developer bearer including: a rotating shaft extending in a first direction; and a developing roller having a developing region facing a photoconductor, the developing roller to: bear developer on a surface of the developing roller; and rotate about the rotating shaft, to convey the developer to the developing region; a doctor blade having a tip facing the surface of the developing roller with a gap between the tip and the surface of the developing roller; and a developer container including a side plate: extending in a second direction perpendicular to the first direction; having a support supporting the rotating shaft; and having a cutout extending from the support: in a third direction perpendicular to the first direction and the second direction away from the tip of the doctor blade; or in the second direction away from the photoconductor.

### CROSS-REFERENCE TO RELATED APPLICATIONS

This patent application is based on and claims priority pursuant to 35 U.S.C. § 119(a) to Japanese Patent Application No. 2025-078889, filed on May 9, 2025, in the Japan Patent Office, the entire disclosure of which is hereby incorporated by reference herein.

### BACKGROUND

### Technical Field

The present disclosure relates to a developing device and an image forming apparatus.

### Related Art

An image forming apparatus includes a photoconductor and a developing device. The developing device includes a developer bearer, a leveler, and a developer container. The developer bearer bears developer on the surface of the developer bearer and rotates to convey the developer to a developing region in which the developer bearer faces the photoconductor. The leveler is disposed so that the tip of the leveler faces the surface of the developer bearer with a predetermined gap. The leveler levels the developer borne on the surface of the developer bearer and conveyed to the developing region so that the layer of the developer on the developer bearer has a certain thickness. The developer container has side plates extending in a direction orthogonal to the rotational axial direction of the developer bearer. The side plate has a support to support the shaft of the developer bearer.

### SUMMARY

The present disclosure described herein provides a developing device including: a developer bearer including: a rotating shaft extending in a first direction; and a developing roller having a developing region facing a photoconductor, the developing roller to: bear developer on a surface of the developing roller; and rotate about the rotating shaft, to convey the developer to the developing region; a doctor blade having a tip facing the surface of the developing roller with a gap between the tip and the surface of the developing roller; and a developer container including a side plate: extending in a second direction perpendicular to the first direction; having a support supporting the rotating shaft; and having a cutout extending from the support: in a third direction perpendicular to the first direction and the second direction away from the tip of the doctor blade; or in the second direction away from the photoconductor, wherein the developer bearer is detachably attached to the developer container in the third direction or the second direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of a copier according to an embodiment;

FIG. 2 is a schematic diagram illustrating a configuration of an image forming unit;

FIG. 3 is a diagram illustrating a configuration inside a developing device;

FIG. 4A is a perspective view of a front side of the image forming unit of FIG. 2, illustrating a configuration of the front side of the image forming unit;

FIG. 4B is a side view of the front side of the image forming unit of FIG. 4A, illustrating the configuration of the front side of the image forming unit;

FIG. 5 is a diagram illustrating a flat spring disposed on a faceplate to apply pressure to a shaft of a developing roller;

FIG. 6A is an enlarged view of a front side of a developing device according to a comparative example, illustrating a schematic configuration of a part of the developing device;

FIG. 6B is an enlarged view of a rear side of the developing device according to the comparative example of FIG. 6A, illustrating a schematic configuration of a part of the developing device;

FIG. 7A is an enlarged view of a front side of a developing device according to the present embodiment, illustrating a schematic configuration of a part of the developing device;

FIG. 7B is an enlarged view of a rear side of the developing device according to the present embodiment of FIG. 7A, illustrating a schematic configuration of a part of the developing device;

FIG. 8 is a diagram illustrating a method for attaching a reinforcing member to a side plate that is different from a method illustrated in FIGS. 7A and 7B;

FIG. 9 is a schematic diagram illustrating a configuration of an image forming unit including a developing device according to a modification;

FIG. 10A is a schematic perspective view of a rear side of the developing device of FIG. 9 in which a back plate is attached to a casing;

FIG. 10B is a schematic perspective view of the rear side of the developing device of FIG. 10A in which the back plate is removed from the casing;

FIG. 11A is a diagram illustrating a relation among a screw support, a bearing to be fitted into the screw support, and a second conveying screw in a comparative example; and

FIG. 11B is a diagram illustrating a relation among a screw support, a bearing to be fitted into the screw support, and a second conveying screw in the modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected, and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The following describes a tandem type color copier (that is referred to as a copier 500) that is an example of an image forming apparatus including a developing device according to an embodiment of the present disclosure.

Electrophotographic image forming apparatuses may include the developing device according to the present disclosure. The image forming apparatus including the developing device is not limited to the following embodiment.

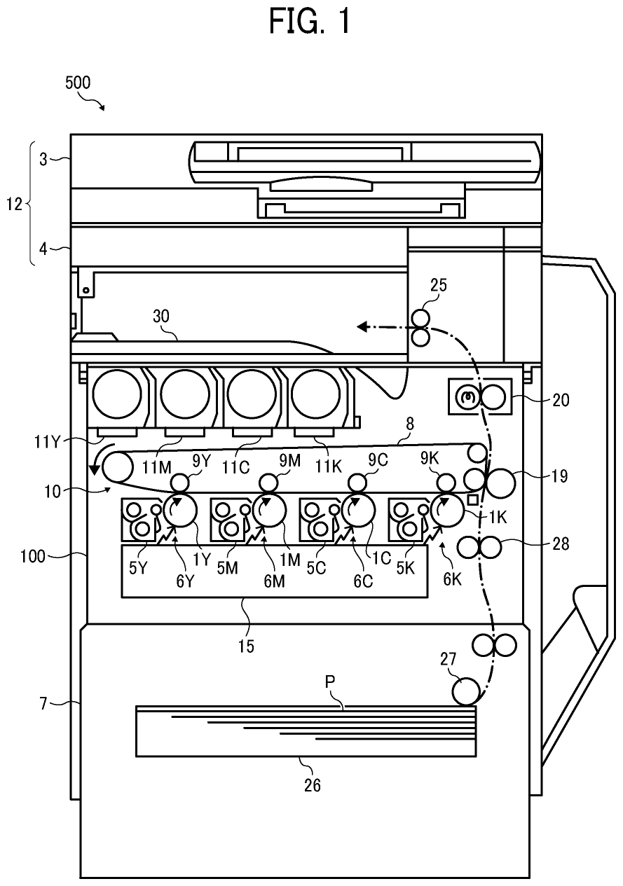

FIG. 1 is a schematic diagram illustrating a configuration of the copier 500.

The copier 500 includes a printer section 100 as a body of the image forming apparatus, a scanner section 12 disposed above the printer section 100, and a sheet feeding section 7 disposed below the printer section 100. The scanner section 12 includes a scanner 4 and a document feeder 3. The document feeder 3 conveys a document to the scanner 4, and the scanner 4 reads image data of the document conveyed. The sheet feeding section 7 includes a sheet tray 26 and a sheet feeding roller 27. The sheet tray 26 stores sheets P as recording media. The sheet feeding roller 27 sends the sheet P in the sheet tray 26 to the printer section 100. A long dashed short dashed line in FIG. 1 indicates a conveyance path of the sheet P in the copier 500.

The upper part of the printer section 100 includes an output tray 30 to stack the sheet P after the printer section 100 forms an output image on the sheet P. The printer section 100 includes an intermediate transfer unit 10 and four image forming units 6Y, 6M, 6C, and 6K as image forming devices forming yellow, magenta, cyan, and black toner images. The image forming units 6Y, 6M, 6C, and 6K include drum-shaped photoconductors 1Y, 1M, 1C, and 1K as image bearers on which the above-described single color toner images are formed. The printer section 100 includes an exposure device 15 to form electrostatic latent images on the surfaces of the photoconductors 1Y, 1M, 1C, and 1K. The image forming units 6Y, 6M, 6C, and 6K include developing devices 5Y, 5M, 5C, and 5K that develop the electrostatic latent images on the surfaces of the photoconductors 1Y, 1M, 1C, and 1K, respectively.

The intermediate transfer unit 10 includes an intermediate transfer belt 8 and four primary transfer bias rollers 9Y, 9M, 9C, and 9K. The primary transfer bias rollers 9Y, 9M, 9C, and 9K are primary transferors to transfer the single color toner images formed on the surfaces of the photoconductors 1Y, 1M, 1C, and 1K to the intermediate transfer belt 8. The single color toner images formed on the surfaces of the photoconductors 1Y, 1M, 1C, and 1K are transferred and superimposed on the surface of the intermediate transfer belt 8 as an intermediate transferor to form a color toner image.

The printer section 100 includes a secondary transfer bias roller 19 to transfer the color toner image on the intermediate transfer belt 8 onto the sheet P. The secondary transfer bias roller 19 faces the intermediate transfer belt 8 to form a secondary transfer nip. The printer section 100 includes a registration roller pair 28 that adjusts a timing to convey the sheet P fed by the sheet feeding roller 27 to the secondary transfer nip. In addition, the printer section 100 includes a fixing device 20 disposed above the secondary transfer nip to fix an unfixed toner image onto the sheet P.

Toner bottles 11Y, 11M, 11C, and 11K are placed below the output tray 30 and above the intermediate transfer unit 10 in the printer section 100. The toner bottles 11Y, 11M, 11C, and 11K contain yellow, magenta, cyan, and black toners that are supplied to the developing devices 5Y, 5M, 5C, and 5K, respectively.

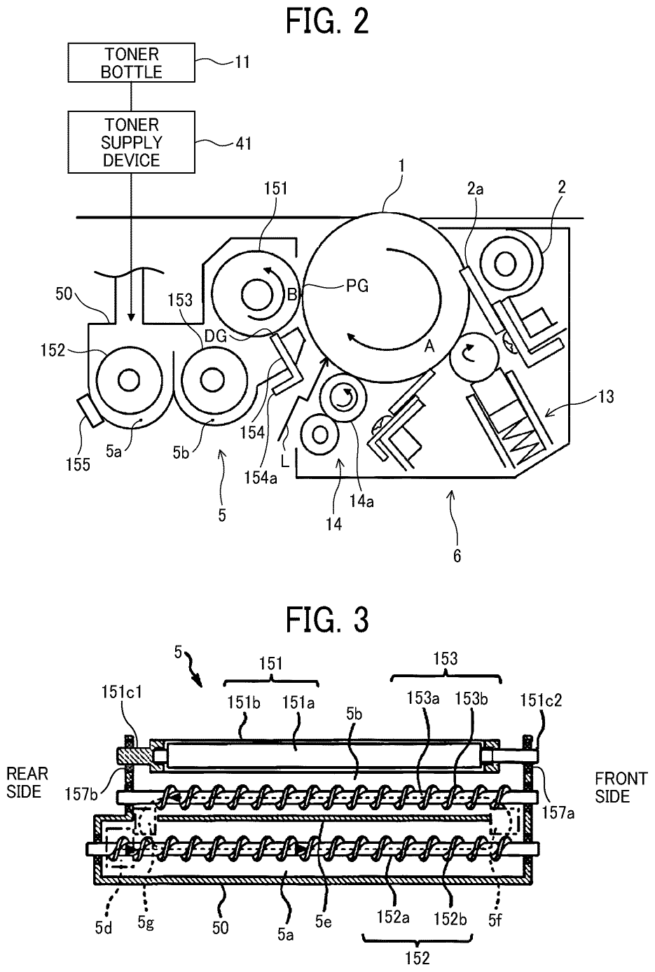

FIG. 2 is a schematic diagram of a configuration of one of the four image forming units 6Y, 6M, 6C, and 6K. FIG. 3 is a diagram illustrating a configuration inside each of the developing devices 5Y, 5M, 5C, and 5K. Since the four image forming units 6Y, 6M, 6C, and 6K have a substantially identical construction and similar work except for the colors of toners used for image forming processes, the suffixes Y, M, C, and K indicating the color of toner are omitted when color discrimination is not necessary.

As illustrated in FIG. 2, the image forming unit 6 is configured as a process cartridge that is one unit including the photoconductor 1 and the developing device 5. The process cartridge is removably installable in the body of the copier 500. The image forming unit 6 includes a photoconductor cleaner 2, a lubricant applying device 13, and a charger 14 in addition to the developing device 5, which are disposed around the photoconductor 1. In the image forming unit 6, the photoconductor cleaner 2 includes a cleaning blade 2a to clean the photoconductor 1, and the charger 14 includes a charging roller 14a to charge the photoconductor 1.

The developing device 5 includes a developing roller 151 as a developer bearer, a first conveying screw 152 as a conveyor, a second conveying screw 153 as the conveyor, and a doctor blade 154 as a leveler. The developing roller 151 faces the photoconductor 1 and is separated from the photoconductor 1 by a developing gap PG that is an appropriately designed distance. The doctor blade 154 faces the developing roller 151 at a doctor region. A developing region entrance seal may be placed between the developing region and the doctor region to prevent toner from scattering.

The first conveying screw 152 includes a rotating shaft 152a and a blade 152b having a helical shape, and the second conveying screw 153 includes a rotating shaft 153a and a blade 153b having a helical shape. Rotating the first conveying screw 152 about the rotating shaft 152a conveys developer in the axial direction of the rotating shaft 152a, and rotating the second conveying screw 153 about the rotating shaft 153a conveys the developer in the axial direction of the rotating shaft 153a. A partition 5e divides a space in a casing 50 of the developing device 5 into a first conveyance path 5a and a second conveyance path 5b. The first conveying screw 152 is placed in the first conveyance path 5a. The second conveying screw 153 is placed in the second conveyance path 5b. The developing device 5 has a communicating hole 5f between one end of the partition 5e in the longitudinal direction of the developing device 5 and a front side plate of the developing device 5. The developing device 5 has a communicating hole 5g between the other end of the partition 5e in the longitudinal direction and a rear side plate of the developing device 5. The first conveyance path 5a and the second conveyance path 5b communicate with each other through the communicating holes 5f and 5g.

The first conveying screw 152 stirs supplied toner with the developer and conveys the developer with the toner. The developer is sufficiently mixed with the toner and passes through the communicating hole 5g, and the second conveying screw 153 receives and conveys the developer. A magnetic force of a magnet inside the developing roller 151 attracts the developer to the developing roller 151. A toner concentration sensor 155 is disposed on a back plate of the casing 50 forming the first conveyance path 5a to continuously detect a toner concentration of the developer passing through the first conveyance path 5a.

The toner concentration sensor 155 continuously detects the toner concentrations of the developer and sends electrical signals as the detected results to a controller that is described below. The controller converts an output voltage sent from the toner concentration sensor 155 to the toner concentration of the developer. The controller compares the output voltage sent from the toner concentration sensor 155 with a target voltage Vtref that is a target value of the output voltage stored in a storage. Subsequently, the controller drives a toner supply device 41 to supply a quantity of toner to a toner supply opening 5d based on the compared result. As a result, a suitable quantity of toner is supplied from the toner bottle 11 to the developer in the first conveyance path 5a. As described above, the controller performs toner supply control.

The developing roller 151 includes a magnet roller 151a and a developing sleeve 151b. The magnet roller 151a has multiple magnets fixed in the magnet roller 151a. The developing sleeve 151b has a tubular shape. The developing sleeve 151b rotates around the magnet roller 151a. The magnet roller 151a is inside the developing sleeve 151b. The developing sleeve 151b is a rotatable cylindrical member made of non-magnetic material. The magnet roller 151a in the present embodiment has multiple magnet poles.

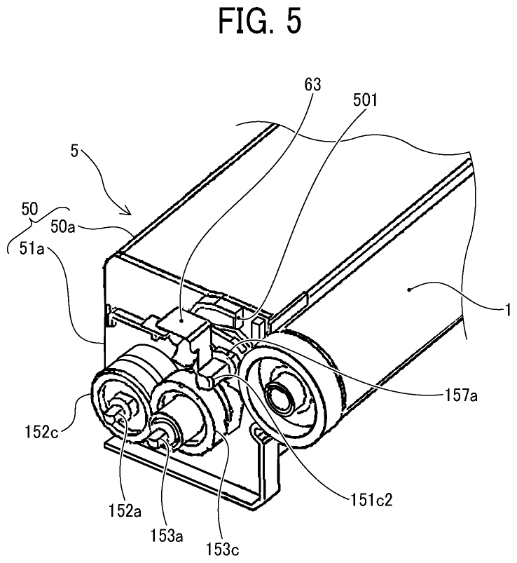

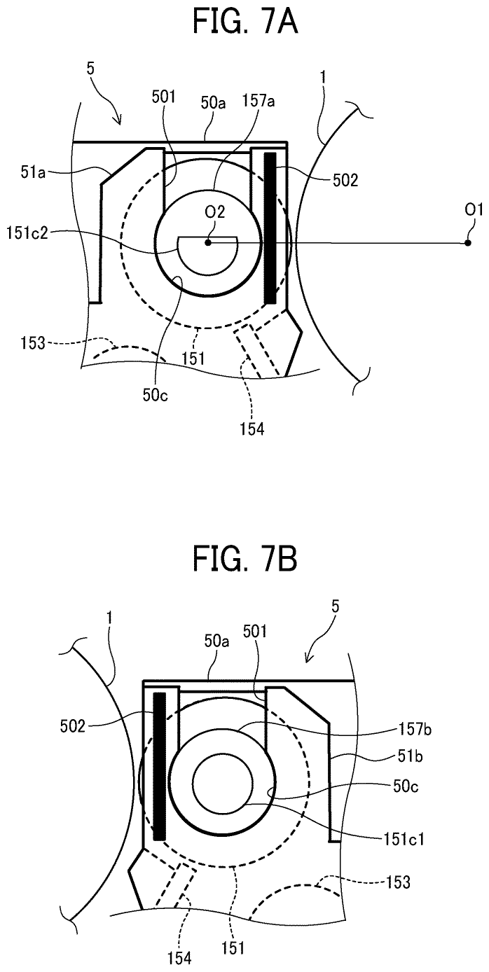

The developing sleeve 151b has a shaft 151c1 that is assembled to a rear side plate 51b of the developing device 5. The shaft 151c1 forms one end of the developing roller 151 in an axial direction of the developing roller 151. This rear shaft 151c1 is rotatably supported by a bearing 157b as a shaft support fitted into a support 50c of the rear side plate 51b of the casing 50 as a developer container of the developing device 5 (see FIG. 7B). The magnet roller 151a has a front shaft 151c2 of the developing roller 151. This front shaft 151c2 is inserted into a shaft support 157a so as not to rotate. The shaft support 157a is fitted into a support 50c of a front side plate 51a of the casing 50 (see FIGS. 5 and 7A).

The casing 50 serves as the developer container of the developing device 5 and holds two-component developer including toner and carrier. The two-component developer may include additives. The first conveying screw 152 and the second conveying screw 153 convey the two-component developer in the casing 50 so that the two-component developer circulates in the casing 50. The developing roller 151 faces the photoconductor 1 to form a developing region. The doctor blade 154 faces the developing roller 151 at a position upstream from the developing region in a direction of surface movement of the developing roller 151 (in other words, in a developer conveyance direction) to set a layer thickness of developer on the developing roller 151.

The doctor blade 154 is made from a metal plate. The doctor blade 154 is disposed under the developing roller 151 so as to face the developing roller 151. One end of the metal plate that is the tip of the metal plate is separated from the surface of the developing roller 151 by a doctor gap (DG) that is designed to be an appropriate distance. Preferably, the other end of the metal plate of the doctor blade 154, which is opposite to the above-described one end of the metal plate, has a bent portion 154a that is bent toward upstream (or downstream) in the developer conveyance direction. The surface movement of the developing roller 151 conveys the developer, and the developer pushes the doctor blade 154, which may bend the doctor blade 154. Such a bend of the doctor blade 154 varies the doctor gap (DG), varying an amount of the developer conveyed to the developing region. The bent portion 154a can prevent the doctor blade 154 from bending and reduce the variation of the doctor gap (DG) and the variation of the amount of the developer in the developing region. The doctor blade 154 made of metal containing iron such as stainless steel is preferable than the one made of aluminum because the manufacturing cost can be reduced.

In the present embodiment, the main component of the toner is polyester resin, and the average particle diameter of the toner is 5.2 μm. The carrier is magnetic fine particles, and the average particle diameter of the carrier is 35 μm. The toner and the carrier are uniformly mixed so that the developer has a toner concentration of 7 wt %. The developing device 5 contains the developer of 250 g. Rotating the first conveying screw 152 and the second conveying screw 153 that are arranged in parallel conveys the developer and stirs the developer with new toner supplied from the toner supply opening 5d at a time, uniformly mixing the toner and the carrier and charging the toner and the carrier.

The second conveying screw 153 is arranged in parallel and close to the developing roller 151 and conveys the uniformly mixed developer in the axial direction of the developing roller 151. At the same time, the magnetic force of the magnet roller 151a disposed inside the developing roller 151 attracts the developer onto the outer circumferential surface of the developing roller 151. The developing roller 151 rotates counterclockwise as indicated by the arrow B in FIG. 2 to convey the developer attracted onto the surface of the developing roller 151 to the doctor blade 154. The doctor blade 154 levels the developer to set the layer thickness of the developer on the developing roller 151. After the doctor blade 154 sets the layer thickness of the developer, rotating the developing roller 151 conveys the developer to the developing region.

A high-voltage power supply applies a voltage to the developing sleeve 151b of the developing roller 151 to form a developing electric field between the photoconductor 1 and the developing roller 151 in the developing region. The developing electric field moves the toner in the developer on the surface of the developing roller 151 to the electrostatic latent image on the surface of the photoconductor 1 to develop the electrostatic latent image on the photoconductor 1.

The following describes typical image forming processes of the copier 500 according to the present embodiment to form a color toner image on the sheet P. Initially, a user sets an original document on a document table of the document feeder 3 and pushes a start button. A conveyance roller of the document feeder 3 conveys the original document on the document table onto a platen (that is, an exposure glass) of the scanner 4. The scanner 4 optically scans the original document on the platen to read image data.

Specifically, the scanner 4 irradiates the image of the original document on the platen with light emitted from a light source (e.g., a lamp), thereby scanning the image of the original document. The light reflected from the surface of the original document is imaged on a color sensor via mirrors and lenses. The multicolor image data of the document is read for each color separation light of red, green, and blue (RGB) by the color sensor and converted into electrical image signals. Further, the image signals are transmitted to an image processor that performs image processing (e.g., color conversion, color calibration, and spatial frequency adjustment) according to the color separation image signals of RGB, and thus image data of yellow, magenta, cyan, and black are obtained.

The yellow, magenta, cyan, and black image data are transmitted to the exposure device 15. The exposure device 15 emits laser beams L toward the surfaces of the photoconductors 1Y, 1M, 1C, and 1K according to the image data of yellow, magenta, cyan, and black, respectively.

Each of the four photoconductors 1Y, 1M, 1C, and 1K rotates clockwise in FIGS. 1 and 2 (that is, a direction indicated by an arrow A in FIG. 2). Initially, the charging roller 14a of the charger 14 uniformly charges the surface of each of the photoconductors 1Y, 1M, 1C, and 1K opposite the charging roller 14a, which is called a charging process. Thus, the surface of each of the photoconductors 1Y, 1M, 1C, and 1K is charged to a charging potential. Subsequently, the charged surface of each of the photoconductors 1Y, 1M, 1C, and 1K reaches a position to receive the laser beam L. The exposure device 15 emits the laser beam L corresponding to four colors from each of four light sources according to the image data. The respective laser beams L pass through different optical paths for components of yellow, magenta, cyan, and black. Each of the surfaces of the photoconductors 1Y, 1M, 1C, and 1K is irradiated with the laser beam L. The above process is an exposure process.

The laser beam L corresponding to the yellow component is emitted to the surface of the photoconductor 1Y for yellow, which is the first from the left in FIG. 1 among the four photoconductors 1Y, 1M, 1C, and 1K. A polygon mirror that rotates at high velocity deflects the laser beam for yellow along the axis of rotation of the photoconductor 1Y for yellow (i.e., a main scanning direction) so that the laser beam scans the surface of the photoconductor 1Y. Thus, an electrostatic latent image corresponding to the yellow component is formed on the surface of the photoconductor 1Y for yellow after the charger 14 charges the surface of the photoconductor 1Y.

Similarly, the exposure device 15 irradiates the outer circumferential surface of the second photoconductor 1M for magenta from the left in FIG. 1 with the laser beam L corresponding to the magenta component to form an electrostatic latent image corresponding to the magenta component. The exposure device 15 irradiates the outer circumferential surface of the third photoconductor 1C for cyan from the left in FIG. 1 with the laser beam L corresponding to the cyan component to form an electrostatic latent image corresponding to the cyan component. The exposure device 15 irradiates the outer circumferential surface of the fourth photoconductor 1K for black from the left in FIG. 1 with the laser beam L corresponding to the black component to form an electrostatic latent image corresponding to the black component.

Then, the surface of each of the photoconductors 1Y, 1M, 1C, and 1K bearing the electrostatic latent images for four colors reaches a position opposite the developing device 5. Each of the developing devices 5Y, 5M, 5C, and 5K holds the developer including the carrier and the color toner and supplies the color toner from the developer on the developing roller 151 to the surface of each of the photoconductors 1Y, 1M, 1C, and 1K to develop the electrostatic latent image on each of the photoconductors 1Y, 1M, 1C, and 1K, which is referred to as a developing process. The developing roller 151 conveys the developer counterclockwise in FIG. 2 as indicated by the arrow B.

The surface of each of the photoconductors 1Y, 1M, 1C, and 1K after the developing process reaches a position opposite the intermediate transfer belt 8. The primary transfer bias rollers 9Y, 9M, 9C, and 9K are disposed at positions where the photoconductors 1Y, 1M, 1C, and 1K face the intermediate transfer belt 8. The primary transfer bias rollers 9Y, 9M, 9C, and 9K contact the inner circumferential surface of the intermediate transfer belt 8. The primary transfer bias rollers 9Y, 9M, 9C, and 9K face the photoconductors 1Y, 1M, 1C, and 1K, respectively, via the intermediate transfer belt 8 to form primary transfer nips. At the primary transfer nips, the four color toner images on the photoconductors 1Y, 1M, 1C, and 1K are sequentially transferred to and superimposed on the intermediate transfer belt 8, forming a multicolor toner image on the intermediate transfer belt 8, which is referred to as a primary transfer process.

After passing through the primary transfer nip, the surface of the photoconductor drum 1 reaches a position opposite the photoconductor cleaner 2. At the position opposite the photoconductor cleaner 2, the cleaning blade 2a scrapes untransferred toner remaining on the surface of the photoconductor drum 1, and scraped toner is collected in the photoconductor cleaner 2, which is referred to as a photoconductor cleaning process. After the photoconductor cleaning process, the surface of the photoconductor 1 passes by a discharger to remove residual charge on the surface of the photoconductor 1. Thus, a series of image forming processes on the photoconductor 1 is completed, and the next image forming processes are prepared.

On the other hand, after the four color toner images on the photoconductors 1Y, 1M, 1C, and 1K are sequentially transferred to and superimposed on the intermediate transfer belt 8 to form the multi color toner image on the intermediate transfer belt 8, the surface of the intermediate transfer belt 8 rotates counterclockwise in FIG. 1 and reaches the secondary transfer nip at which the secondary transfer bias roller 19 faces the intermediate transfer belt 8. The sheet feeding roller 27 feeds the sheet P from the sheet tray 26 that stores the sheets P to the conveyance path, and the sheet P passes along a conveyance guide, is guided to the registration roller pair 28, contacts the registration roller pair 28, and temporarily stops. The registration roller pair 28 feeds the sheet P, which has contacted the registration roller pair 28, toward the secondary transfer nip, timed to coincide with the arrival of the multicolor toner image on the intermediate transfer belt 8. The multicolor toner image borne on the intermediate transfer belt 8 is secondarily transferred onto the sheet P at the secondary transfer nip, which is referred to as a secondary transfer process.

The surface of the intermediate transfer belt 8 that has passed through the secondary transfer nip reaches a position opposite the intermediate-transfer-belt cleaner. After the secondary transfer process, residual toner not transferred to the sheet P is left on the surface of the intermediate transfer belt 8. At the position, the intermediate-transfer-belt cleaner collects the residual toner adhering to the intermediate transfer belt 8 to complete a series of transfer processes performed on the intermediate transfer belt 8.

The untransferred toner scraped from the surface of the photoconductor 1 by the cleaning blade 2a passes through a collected toner conveyance path and is collected as waste toner in a waste-toner container. The residual toner scraped from the surface of the intermediate transfer belt 8 by the intermediate-transfer-belt cleaner and toner of pattern images for a process control pass through the collected toner conveyance path and are collected as waste toner in the waste-toner container.

After the multicolor toner image is transferred to the sheet P at the secondary transfer nip, the sheet P is conveyed to the fixing device 20.

The fixing device 20 includes a fixing roller and a pressure roller that form a fixing nip. Heat and pressure in the fixing nip fixes the multicolor toner image onto the sheet P. After the sheet P passes through the fixing device 20, a sheet ejection roller pair 25 ejects the sheet P as an output image to the exterior of the printer section 100, and the ejected sheet P is stacked on the output tray 30 to complete the series of image forming processes.

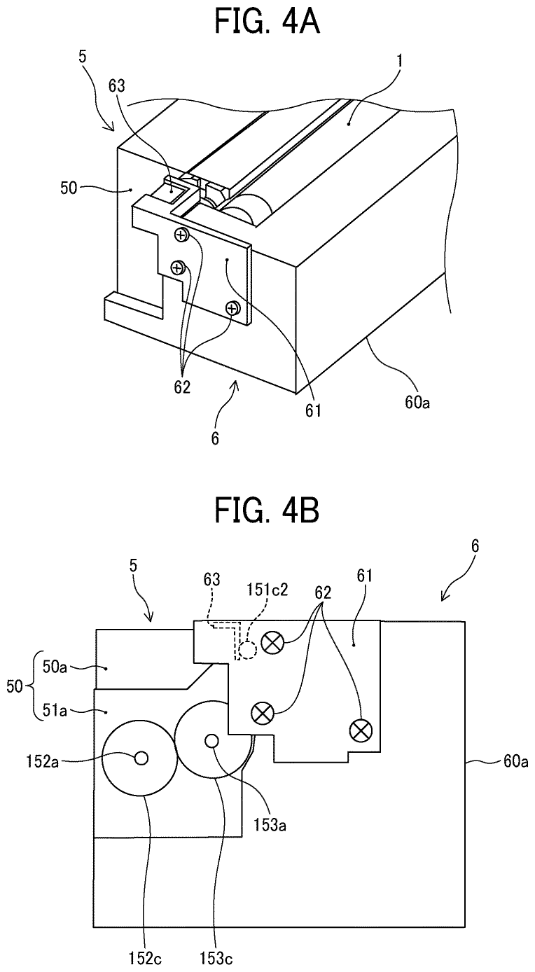

FIG. 4A is a perspective view of a front side of the image forming unit 6, illustrating a configuration of the front side of the image forming unit 6. FIG. 4B is a side view of the front side of the image forming unit 6, illustrating the configuration of the front side of the image forming unit 6. The image forming unit 6 includes a unit case 60a to accommodate the photoconductor 1, the photoconductor cleaner 2, the lubricant applying device 13 and the charger 14. In addition, the image forming unit 6 includes a faceplate 61 assembled to the unit case 60a by screws 62. The faceplate serves as a positioner determining the developing gap PG between the photoconductor 1 and the developing roller 151.

A flat spring 63 made of metal plate is disposed on the faceplate 61. The flat spring 63 presses the shaft 151c2 of the developing roller 151 against the photoconductor 1 as illustrated in FIGS. 4B and 5. Regarding the rear side of the unit case 60a, a flat spring disposed on a faceplate similarly presses the shaft of the developing roller 151 against the photoconductor 1. The pressure from these flat springs 63 prevents the developing roller 151 from separating from the photoconductor 1 and keeps the target developing gap PG.

As illustrated in FIGS. 4B and 5, a gear 152c is attached to the first conveying screw 152, and a gear 153c is attached to the second conveying screw. The gears 152c and 153c transmit a driving force between the first conveying screw 152 and the second conveying screw 153. The casing 50 has a cutout 501 as illustrated in FIG. 5 to insert or pull the developing roller 151 into or out of the casing 50.

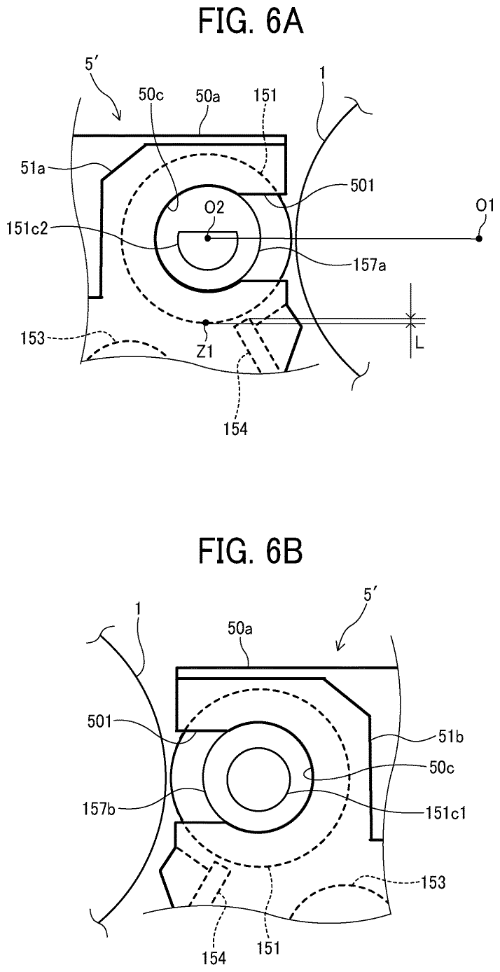

FIGS. 6A and 6B illustrate a configuration of a part of a developing device 5′ according to a comparative example. FIG. 6A is an enlarged view of a front side of the developing device 5′; and FIG. 6B is an enlarged view of a rear side of the developing device 5′. As illustrated in FIG. 6A, the front side plate 51a as the side plate of the casing 50 in the comparative example has the cutout 501 communicating the support 50c supporting the front shaft 151c2 of the developing roller 151 via the shaft support 157a to easily attach and detach the developing roller 151 to and from the casing 50 as the developer container. As illustrated in FIG. 6B, the rear side plate 51b as the side plate of the casing 50 also has the cutout 501 communicating the support 50c supporting the rear shaft 151c1 of the developing roller 151 via the bearing 157b. In the configuration of the comparative example, the cutout 501 extends from the support 50c to the photoconductor 1 in parallel with a line connecting the rotation center O1 of the photoconductor 1 and the rotation center O2 of the developing roller 151.

The doctor blade 154 is arranged downstream from the lowest point Z1 (lower end) of the developing roller 151 in the direction of surface movement of the developing roller 151 because the doctor blade 154 sets the layer thickness of developer after an attracting magnet pole of the magnet roller 151a in the developing roller 151 attracts the developer to the surface of the developing roller 151 around the lowest point Z1. Additionally, as illustrated in FIG. 6A, the lowest point Z1 of the developing roller 151 is located below the tip of the doctor blade 154 by a distance L in a vertical direction of the developing device that is orthogonal to the line connecting the rotation center O1 of the photoconductor 1 and the rotation center O2 of the developing roller 151.

When the developing roller 151 is removed from the casing 50, the shaft support 157a and the bearing 157b that are fitted into the supports 50c of the casing 50 are moved in the axial direction and removed from the casing 50. Subsequently, the shafts 151c1 and 151c2 of the developing roller 151 are moved toward the photoconductor 1, pass through the cutout 501, and are removed from the casing 50. As a result, the developing roller 151 is removed from the casing 50.

If the casing has the support 50c having a hole shape and does not have the cutout 501, the developing roller 151 is moved in the axial direction to remove the shafts 151c1 and 151c2 from the support 50c. Removing the shafts 151c1 and 151c2 from the support 50c needs a predetermined gap between the developing sleeve 151b and each of the side plates 51a and 51b, which increases the size of the developing device 5 in the axial direction. In contrast, the cutout 501 in the casing enables removing the shafts 151c1 and 151c2 from the support 50c without moving the developing roller 151 in the axial direction. As a result, the gap between the developing sleeve 151b and each of the side plates 51a and 51b can be reduced, which prevents the size of the developing device 5 in the axial direction from increasing.

Since the lowest point Z1 of the developing roller 151 is located below the tip of the doctor blade 154 by the distance L, moving the developing roller 151 toward the photoconductor 1 to remove the developing roller 151 from the casing 50 moves the surface of the developing roller 151 to be close to the tip of the doctor blade 154.

Therefore, the surface of the developing roller 151 may hit the tip of the doctor blade 154 and damage the doctor blade 154. To avoid the damage of the doctor blade 154, the doctor blade 154 is removed from the casing 50 before the developing roller 151 is replaced in the configuration according to the comparative example. As a result, the configuration according to the comparative example makes an additional work that is adjustment of the doctor gap (DG) after the replacement of the developing roller 151, causing an issue that replacement workability of the developing roller 151 is poor.

FIGS. 7A and 7B illustrate a schematic configuration of a part of the developing device 5 according to the present embodiment. FIG. 7A is an enlarged view of a front side of the developing device 5; and FIG. 7B is an enlarged view of a rear side of the developing device 5.

As illustrated in FIG. 7A (and FIG. 5), the front side plate 51a as the side plate in the developing device 5 has the cutout 501 communicating with the support 50c supporting the front shaft 151c2 of the developing roller 151 via the shaft support 157a. As illustrated in FIG. 7B, the rear side plate 51b, as the side plate in the developing device 5, has the cutout 501 communicating with the support 50c supporting the rear shaft 151c1 of the developing roller 151 via the bearing 157b. The cutouts 501 extend upward. As illustrated in FIGS. 7A and 7B, the developing roller 151 and the doctor blade 154 are arranged as follows on a cross section orthogonal to the axial direction of the developing roller 151. When a first position on the surface of the developing roller 151 at which the developing roller 151 faces the tip of the doctor blade 154 and a second position upstream from the first position on the surface of the developing roller 151 in a rotational direction of the developing roller 151 are assumed, the second position is, in a direction orthogonal to the line connecting the rotation center O1 of the photoconductor 1 and the rotation center O2 of the developing roller 151 on the cross section, either at the same position as the tip of the doctor blade 154 or farther from the line than the tip of the doctor blade 154. In addition, the cutout 501 extends from the support 50c in a direction away from the tip of the doctor blade along the direction orthogonal to the line.

When the developing roller 151 is removed from the casing 50, an upper case 50a of the casing 50 is first removed. Secondly, the shaft support 157a and the bearing 157b that are fitted into the support 50c are moved in the axial direction and removed from the casing 50. Thirdly, the shafts 151c1 and 151c2 of the developing roller 151 are moved upward, pass through the cutouts 501, and are removed from the casing 50. As a result, the developing roller 151 is removed from the casing 50.

As illustrated in FIGS. 7A and 7B, the cutout 501 extends upward from the support 50c. In other words, the cutout 501 extends in the direction orthogonal to the line connecting the rotation center O1 of the photoconductor 1 and the rotation center O2 of the developing roller 151. When the developing roller 151 is removed from the casing 50, the surface of the developing roller 151 moves in a direction away from the tip of the doctor blade 154 that is located below the developing roller 151. As a result, the surface of the developing roller 151 does not hit the doctor blade 154 when the developing roller 151 is removed from the casing 50, which is different from the configuration according to the comparative example illustrated in FIGS. 6A and 6B. The developing roller 151 can be replaced without removing the doctor blade 154. As a result, the configuration according to the present embodiment does not make the additional work that is the adjustment of the doctor gap (DG) after the replacement of the developing roller 151, enhancing the replacement workability of the developing roller 151.

In FIGS. 7A and 7B, a length between the photoconductor 1 and the cutout 501 in each of the side plates 51a and 51b in a lateral direction (that is, a direction in parallel with the line connecting the rotation center O1 of the photoconductor 1 and the rotation center O2 of the developing roller 151) is short. In addition, a length between the photoconductor 1 and the support 50c in the lateral direction is short. Therefore, these portions having the above-described short lengths easily deform in the lateral direction. Fitting the shaft support 157a and the bearing 157b into the supports 50c may deform these portions toward the photoconductor 1. In addition, as illustrated in FIGS. 4A, 4B, and 5, the flat spring 63 disposed on the faceplate 61 presses each shaft 151c1 and 151c2 of the developing roller 151 against the photoconductor 1. The pressure of the flat spring 63 may deform the portion between the photoconductor 1 and the cutout 501 and the portion between the photoconductor 1 and the support 50c in each of the side plates 51a and 51b toward the photoconductor 1. Deforming the portion between the cutout 501 and the photoconductor 1 and the portion between the support 50c and the photoconductor 1 in each of the side plates 51a and 51b may change the developing gap (PG) to be smaller than the target developing gap (PG). The change of the developing gap (PG) may change the ease of the movement of the toner from the developing roller 151 to the photoconductor 1, affecting the image density.

Lengthening the portion between the cutout 501 and the photoconductor 1 and the portion between the support 50c and the photoconductor 1 in each of the side plates 51a and 51b in the lateral direction in FIGS. 7A and 7B may prevent the portions from deforming in the lateral direction. However, lengthening these portions in the lateral direction causes the side plates 51a and 51b to be in contact with the photoconductor 1. As a result, the developing gap (PG) cannot be the target value.

To countermeasure the above disadvantage, in the present embodiment, a reinforcing member 502 is disposed on the portion between the cutout 501 and the photoconductor 1 and the portion between the support 50c and the photoconductor 1 in each of the side plates 51a and 51b to reinforce the portions as illustrated in FIGS. 7A and 7B. In the vertical direction, the reinforcing member 502 extends from a portion close to the upper end of each of the side plates 51a and 51b to a portion close to the lower end of the supports 50c. The reinforcing member 502 in the present embodiment is made of metal such as iron but may be made of a material having a strength higher than the strength of the side plates 51a and 51b that are made of resin.

The reinforcing member 502 reinforces the portion between the cutout 501 and the photoconductor 1 and the portion between the support 50c and the photoconductor 1 in each of the side plates 51a and 51b to prevent these portions from deforming in the lateral direction of FIGS. 7A and 7B. In other words, the reinforcing member 502 can reduce the deformation in the portion between the cutout 501 and the photoconductor 1 and the portion between the support 50c and the photoconductor 1 in each of the side plates 51a and 51b caused by the flat springs 63 on the faceplates 61 pressing the shafts 151c1 and 151c2 against the photoconductor 1 and caused by fitting the shaft support 157a and the bearing 157b into the supports 50c.

As a result, the above-described structure prevents the developing roller 151 from approaching photoconductor 1 and keeps the target developing gap PG.

The reinforcing member 502 may be assembled to each of the side plates 51a and 51b by insert molding. Alternatively, a hole may be formed in the portion between the cutout 501 and the photoconductor 1 and the portion between the support 50c and the photoconductor 1 in each of the side plates 51a and 51b, and the reinforcing member 502 may be fitted into the hole.

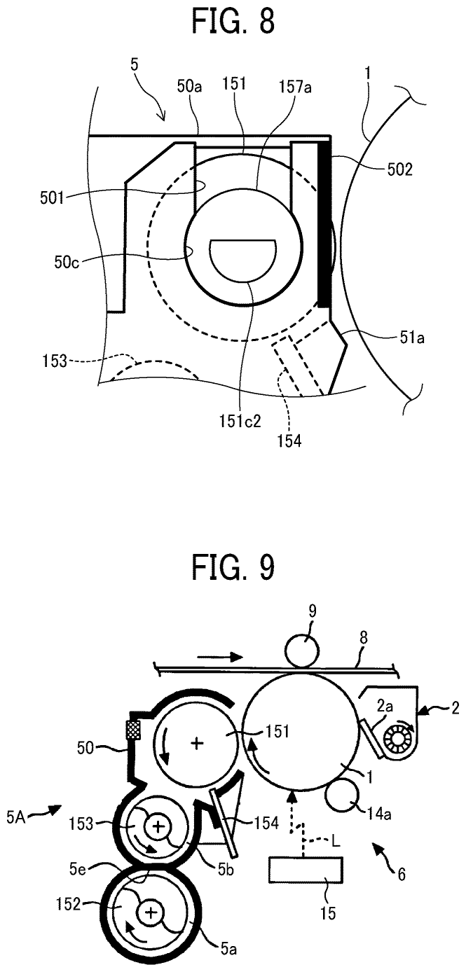

As illustrated in FIG. 8, a stepped surface may be formed on a portion facing the photoconductor 1 and corresponding to the portion between the cutout 501 and the photoconductor 1 and the portion between the support 50c and the photoconductor 1 in each of the side plates 51a and 51b, and the reinforcing member 502 may be attached to the stepped surface by adhesive. The configuration illustrated in FIG. 8 is simple. In contrast, the configuration illustrated in FIGS. 7A and 7B can avoid the occurrence of discharge between the photoconductor 1 and the reinforcing member 502 made of a conductor such as metal.

A modification is described below.

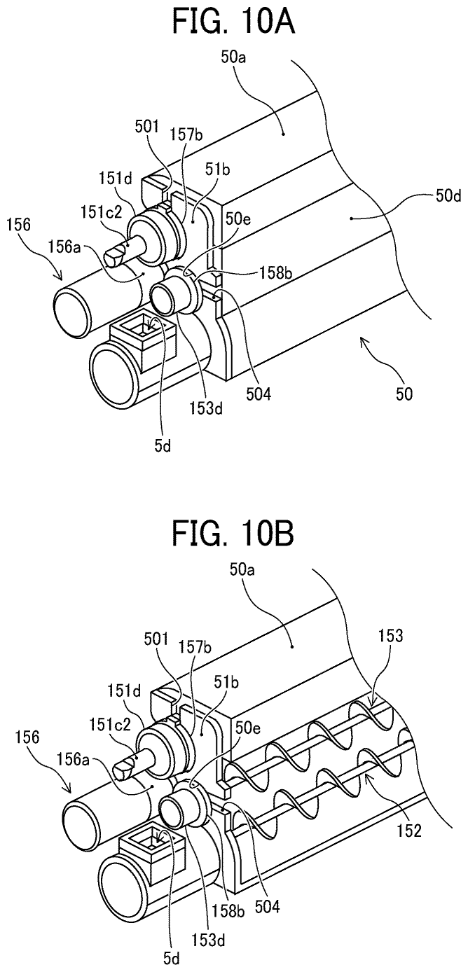

FIG. 9 is a schematic diagram illustrating a configuration of the image forming unit 6 including a developing device 5A according to the modification. FIGS. 10A and 10B are schematic perspective views of the rear side of the developing device 5A according to the modification. In FIG. 10A, a back plate 50d is attached to the casing 50. In FIG. 10B, the back plate 50d is removed from the casing 50.

As illustrated in FIG. 9, the developing device 5A according to the modification includes the first conveying screw 152 disposed in the first conveyance path 5a and the second conveying screw 153 disposed in the second conveyance path 5b, and the first conveyance path 5a is disposed below the second conveyance path 5b. As illustrated in FIGS. 10A and 10B, the developing device 5A according to the modification includes the casing 50 including the rear side plate 51b, and the rear side plate 51b has a second cutout 504 as another cutout for attaching and detaching a conveyor to attach and detach the second conveying screw 153 to and from the casing 50. The rear side plate 51b has a screw support 50e to rotatably support the rotating shaft 153a of the second conveying screw 153 via a bearing 158b. The second cutout 504 communicates with the screw support 50e and extends in a direction away from the photoconductor 1. Similarly to the rear side plate 51b, the front side plate 51a has the second cutout and the screw support to rotatably support the rotating shaft 153a of the second conveying screw 153 via a bearing, and the second cutout 504 communicates with the screw support and extends in the direction away from the photoconductor 1.

As illustrated in FIGS. 10A and 10B, the developing device 5A includes a joint 156 to transmit a driving force of a driver in the body of the copier 500. The joint 156 is rotatably supported by a shaft fixed on the rear side plate 51b. The joint 156 includes a gear 156a at the root of the joint 156, and the gear 156a meshes with a developing gear 151d disposed on the shaft 151c2 of the developing roller 151 and a screw gear 153d disposed on the rotating shaft 153a of the second conveying screw 153.

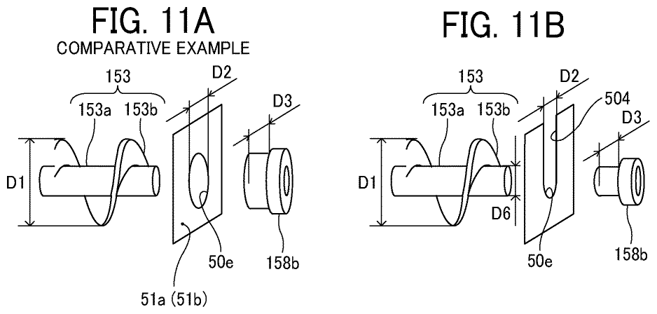

The following describes a comparative example regarding attaching and detaching the second conveying screw 153 to and from the casing. The gear and the bearing 158b are assembled to the rotating shaft 153a of the second conveying screw 153. Firstly, the gear and the bearing 158b are removed from the rotating shaft 153a. Secondly, the second conveying screw 153 is moved in the axial direction and pulled from the screw support 50e that is a hole in the front side plate 51a or the rear side plate 51b to remove the second conveying screw 153 from the casing 50. As a result, as illustrated in FIG. 11A, the diameter D2 of the screw support 50e that is the hole in the front side plate 51a or the rear side plate 51b is larger than the outer diameter D1 of the blade 153b of the second conveying screw 153 in the comparative example. The bearing 158b receiving the rotating shaft 153a of the second conveying screw 153 is fitted into the screw support 50e having the large diameter D2. Therefore, the diameter D3 of the bearing 158b becomes large. As a result, the size of the developing device becomes large.

The following describes the modification regarding attaching and detaching the second conveying screw 153 to and from the casing. Firstly, the back plate 50d is removed from the casing 50 as illustrated in FIG. 10B. Secondly, the gear and the bearing 158b attached to the rotating shaft 153a of the second conveying screw 153 are removed from the rotating shaft 153a. Thirdly, the second conveying screw 153 is moved in a direction orthogonal to the axial direction of the second conveying screw 153. In other words, the second conveying screw is moved in the direction away from the photoconductor 1. The second conveying screw 153 passes through the second cutout 504 and is removed from the casing 50. As a result, as illustrated in FIG. 11B, the diameter D2 of the screw support 50e in the front side plate 51a and the rear side plate 51b is designed to be smaller than the outer diameter D1 of the blade 153b of the second conveying screw 153 and larger than the diameter D6 of the rotating shaft 153a of the second conveying screw 153 in the modification (D6<D2<D1). Accordingly, the size of the developing device in the modification can be designed to be smaller than the developing device in the comparative example in which the diameter D2 of the screw support 50e is larger than the outer diameter D1 of the blade of the second conveying screw as illustrated in FIG. 11A (D1<D2).

In addition, the second cutout 504 extending in the direction away from the photoconductor 1 in the modification enables the second conveying screw 153 to be attached to and detached from the casing 50 without removing the developing roller 151 and the first conveying screw 152 from the casing 50. According to the modification, the replacement workability of the second conveying screw 153 can be enhanced. As illustrated in FIG. 10A, the back plate 50d covers the second cutout 504 to prevent the developer from leaking out from the second cutout 504.

If the back plate 50d and the side plates 51a and 51b are molded as one molded component, the second cutout 504 may be designed to extend upward from the screw support 50e. In this configuration, the upper case 50a and the developing roller 151 are removed to replace the second conveying screw 153. As a result, the replacement workability may not be enhanced. However, also in this configuration, the diameter of the screw support 50e can be designed to be smaller than the outer diameter of the blade 153b of the second conveying screw 153, reducing the size of the developing device 5A.

Also in this modification, the developing device 5A has the cutout 501 to attach and detach the developing roller 151 to and from the casing. The cutout 501 communicates with the support 50c and extends upward from the support 50c as illustrated in FIGS. 10A and 10B.

However, the cutout 501 may be designed to extend in the direction away from the photoconductor 1, similarly to the second cutout 504. Also in this configuration, the developing roller 151 can be moved so that the surface of the developing roller 151 moves in the direction away from the tip of the doctor blade 154 that is located closer to the photoconductor than the lowest point Z1 of the developing roller 151 to remove the developing roller 151 from the casing 50. The developing roller 151 can be replaced without removing the doctor blade 154. As a result, the configuration according to the modification does not make the additional work that is the adjustment of the doctor gap (DG) after the replacement of the developing roller 151, enhancing the replacement workability of the developing roller 151.

The developing device 5 illustrated in FIG. 2 has the first conveyance path 5a disposed beside the second conveyance path 5b in which the second conveying screw 153 is disposed. In the developing device 5, the second cutout 504 is designed to extend upward from the screw support 50e. To remove the second conveying screw 153 from the casing 50, the upper case 50a and the developing roller 151 are removed, and the second conveying screw 153 is moved in the direction orthogonal to the axial direction of the second conveying screw 153. Thus, also in the developing devise illustrated in FIG. 2, the diameter of the screw support 50e can be designed to be smaller than the outer diameter of the blade of the second conveying screw, reducing the size of the developing device 5.

A developing device (5, 5A) includes: a developer bearer (151) including: a rotating shaft (151c1, 151c2) extending in a first direction; and a developing roller (151) having a developing region facing a photoconductor (1), the developing roller to: bear developer on a surface of the developing roller; and rotate about the rotating shaft (151c1, 151c2), to convey the developer to the developing region; a doctor blade (154) having a tip facing the surface of the developing roller (151) with a gap between the tip and the surface of the developing roller; and a developer container (50) including a side plate (51a, 51b): extending in a second direction perpendicular to the first direction; having a support (50c) supporting the rotating shaft (151c1, 151c2); and having a cutout (501) extending from the support (50c): in a third direction perpendicular to the first direction and the second direction away from the tip of the doctor blade; or in a second direction away from the photoconductor (1), wherein the developer bearer (151) is detachably attached to the developer container (50) in the third direction or the second direction.

The doctor blade (154): is disposed below the developer bearer (151) in the third direction; and extends in the third direction and is inclined relative to the third direction, the developing roller (151) has a lower end (Z1) disposed, in the third direction: at a same position with the tip of the doctor blade (154); or below the tip of the doctor blade (154), and the cutout (501) extends from the support (50c) upward in the third direction away from the tip of the doctor blade (154).

The developing device (5, 5A) further includes: a reinforcing member (502) on the side plate (51a, 51b) and disposed between the support (50c) and the photoconductor (1) in the second direction.

The developer container (50) includes a conveyor (153) including a shaft (153a) to convey the developer in the developer container (50) toward the developing region, the side plate (51a, 51b) has: a conveyor support (50e) to support the shaft (153a) of the conveyor (153); and another cutout (504) extending from the conveyor support (50e) in the second direction, wherein the conveyor (153) is detachably attached to the developer container (50) in the second direction.

An image forming apparatus comprising the developing device (5, 5A).

The above-described embodiments are illustrative and do not limit this disclosure. Thus, numerous additional modifications and variations are possible in light of the above teachings. For example, elements and/or features of different illustrative embodiments may be combined with each other and/or substituted for each other within the scope of this disclosure.

The configurations according to the above-descried embodiment and the modification are examples, and embodiments of the present disclosure are not limited to the above. For example, the following aspects can achieve effects described below.

### First Aspect

In a first aspect, a developing device includes a developer bearer such as the developing roller 151, a leveler such as the doctor blade 154, and a developer container such as the casing 50. The developer bearer bears developer on the surface of the developer bearer. The surface of the developer bearer moves to convey the developer to a developing region on the developer bearer at which the developer bearer faces a photoconductor 1. The tip of the leveler faces the surface of the developer bearer with a predetermined gap (a doctor gap DG). The leveler levels a layer thickness of the developer borne on the surface of the developer bearer to convey the developer to the developing region. The developer container includes a side plate such as the front side plate 51a and the rear side plate 51b. The side plate extends in a direction orthogonal to the rotational axial direction of the developer bearer. The support 50c is formed in the side plate to support the shaft 151c1 or 151c2 of the developer bearer. The cutout 501 is formed in the side plate to attach and detach the developer bearer to and from the developer container. The cutout 501 extends from the support so that the surface of the developer bearer moves in a direction away from the tip of the leveler when the developer bearer is removed from the developer container.

In the comparative example, the cutout extending from the support toward the photoconductor is formed to remove the developer bearer from the developer container as follows. The developer bearer is moved toward the photoconductor, and the shaft passes through the cutout to remove the developer bearer from the support. As a result, the developer bearer is removed from the developer container. However, when the developer bearer is removed from the developer container as described above, the surface of the developer bearer moves in a direction in which the developer bearer approaches the tip of the leveler. Therefore, the surface of the developer bearer may hit the tip of the leveler and damage the leveler. Accordingly, the developer bearer is removed from the developer container after the leveler is removed from the developer container. As a result, the configuration according to the comparative example makes an additional work that is adjustment of the gap between the surface of the developer bearer and the tip of the leveler after the replacement of the developer bearer, causing an issue that replacement workability of the developer bearer is poor.

In contrast, the cutout in the first aspect extends from the support so that the surface of the developer bearer moves in a direction away from the tip of the leveler when the developer bearer is removed from the developer container. As a result, the surface of the developer bearer does not hit the tip of the leveler when the developer bearer is removed from the developer container. Therefore, under the condition that the leveler is attached to the developer container, the developer bearer can be attached and detached from the developer container, which does not make the additional work that is the adjustment of the gap between the surface of the developer bearer and the tip of the leveler after the replacement of the developer bearer. As a result, the replacement workability of the developer bearer can be enhanced.

### Second Aspect

In a second aspect, the developing device according to the first aspect is configured as follows in a cross section orthogonal to the rotational axial direction of the developer bearer such as the developing roller 151. The surface of the developer bearer has a facing position at which the surface of the developer bearer faces the tip of the leveler such as the doctor blade 154. The surface of the developer bearer moves in a surface movement direction. In a direction orthogonal to a line connecting a shaft center such as the rotation center O1 of the photoconductor 1 and a shaft center such as the rotation center O2 of the developer bearer (that is, the vertical direction in FIGS. 7A and 7B), the surface of the developer bearer upstream from the facing position in the surface movement direction is at the same position as the tip of the leveler or farther from the line than the tip of the leveler. The cutout 501 extends from the support 50c in a direction away from the leveler along the direction orthogonal to the line (that is, upward in FIGS. 7A and 7B) or a direction away from the photoconductor.

According to the second aspect, moving the developer bearer such as the developing roller 151 in the direction away from the tip of the leveler removes the developer bearer from the developer container such as the casing 50 as described in the embodiment.

### Third Aspect

In a third aspect, the developing device according to the first aspect or the second aspect includes the reinforcing member 502 between the photoconductor 1 and the support 50c on the side plate, such as the front side plate 51a or the rear side plate 51b, when the developing device is viewed on a cross section orthogonal to the rotational axial direction of the developer bearer such as the developing roller 151.

According to the third aspect, the reinforcing member 502 reinforces the part of the side plate, such as the front side plate 51a or the rear side plate 51b, between the photoconductor 1 and the support 50c to prevent the part from deforming toward the photoconductor 1 as described in the embodiment. The above-described configuration prevents the developing gap (PG) between the developer bearer and the photoconductor in the developing region from narrowing from the target developing gap (PG). As a result, the developing device can maintain the target developing performance.

### Fourth Aspect

In a fourth aspect, the developing device according to any one of the first to third aspects includes a conveyor, such as the second conveying screw 153, to convey the developer within the developer container, such as the casing 50. A conveyor support, such as the screw support 50e, and a cutout for attaching and detaching the conveyor, such as the second cutout 504, are formed in the side plate, such as the front side plate 51a or the rear side plate 51b. The conveyor support supports the shaft of the conveyor, such as the rotating shaft 153a. The cutout for attaching and detaching the conveyor communicates the conveyor support to attach and detach the conveyor to and from the developer container.

According to the fourth aspect, the conveyor is attached to and detached from the developer container as follows. As described in the modification, the conveyor, such as the second conveying screw 153, is moved in a direction orthogonal to the axial direction. The shaft of the conveyor, such as the rotating shaft 153a, supported by the conveyor support, such as the screw support 50e, passes through the cutout for attaching and detaching the conveyor, such as the second cutout 504. The conveyor is removed from or inserted into the conveyor support. As a result, the conveyor is attached to and detached from the developer container such as the casing 50. As described above, moving the conveyor in the direction orthogonal to the axial direction enables the conveyor to be attached to and detached from the developer container. The diameter of the conveyor support can be reduced compared with the developing device in which moving the conveyor in the axial direction to remove or insert the conveyor from or into the conveyor support enables the conveyor to be attached to and detached from the developer container. As a result, the size of the developing device can be reduced.

### Fifth Aspect

In a fifth aspect, an image forming apparatus includes the photoconductor 1 and the developing device 5 according to any one of the first to fourth aspects to develop a latent image formed on the surface of the photoconductor 1.

According to the fifth aspect, the size of the image forming apparatus can be reduced, and the replacement workability of the developer bearer, such as the developing roller 151, can be enhanced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A developing device comprising:
a developer bearer including:
a rotating shaft extending in a first direction; and
a developing roller having a developing region facing a photoconductor, the developing roller to:
bear developer on a surface of the developing roller; and
rotate about the rotating shaft, to convey the developer to the developing region;
a doctor blade having a tip facing the surface of the developing roller with a gap between the tip and the surface of the developing roller; and
a developer container including a side plate:
extending in a second direction perpendicular to the first direction;
having a support supporting the rotating shaft; and
having a cutout extending from the support:
in a third direction perpendicular to the first direction and the second direction away from the tip of the doctor blade; or
in the second direction away from the photoconductor,
wherein the developer bearer is detachably attached to the developer container in the third direction or the second direction.

2. The developing device according to claim 1,
wherein the doctor blade:
is disposed below the developer bearer in the third direction; and
extends in the third direction and is inclined relative to the third direction,
the developing roller has a lower end disposed, in the third direction:
at a same position with the tip of the doctor blade; or
below the tip of the doctor blade, and
the cutout extends from the support upward in the third direction away from the tip of the doctor blade.

3. The developing device according to claim 1, further comprising:
a reinforcing member on the side plate and disposed between the support and the photoconductor in the second direction.

4. The developing device according to claim 1,
wherein the developer container includes a conveyor including a shaft to convey the developer in the developer container toward the developing region, and
the side plate has:
a conveyor support to support the shaft of the conveyor; and
another cutout extending from the conveyor support in the second direction,
wherein the conveyor is detachably attached to the developer container in the second direction.

5. An image forming apparatus comprising the developing device according to claim 1.
